(19) United States
(12) Patent Application Publication
(10) Pub. No.: US 2015/0245728 A1
(43) Pub. Date: Sep. 3, 2015

(54) ELECTRICAL ROTATING CORING APPARATUS

(71) Applicant: Shadi Rashid, Corona, CA (US)

(72) Inventor: Shadi Rashid, Corona, CA (US)

(21) Appl. No.: 14/194,738

(22) Filed: Mar. 2, 2014

(51) Int. Cl. A47J 25/00

(52) U.S. Cl. CPC A47J 25/00

(57) ABSTRACT

An electrical rotating coring apparatus for coring a squash in the preparation of Kousa Mahshi. The electrical rotating coring apparatus comprises a base member, a manakra dock, a securing ring, and a conventional manakra. The base member is an electrically powered rotational device which enables a user to hold a utilize the electrical rotating coring apparatus. The manakra dock enable the electrical rotating coring apparatus to receive, hold and spin the manakra. The securing ring is configured to mechanically attach to manakra dock and lock a manakra in place on the manakra dock in place. An electric motor and battery are disposed in the base member to generate the rotation from electricity. The motor driven electricity is utilized to cause a manakra held in the manakra dock by a securing to spin.

### BACKGROUND OF THE INVENTION

1. Field of the Invention

This invention relates generally to tool accessories and, more particularly, to a socket extension bar for a driving tool which allows a user to adjust the length of the extension.

2. Description of the Prior Art

The preparation of many dishes and cuisines around the world require coring a fruit or vegetable so that it can be stuffed. For example, the Middle Eastern dish of Kousa Mahshi, or Stuffed Marrows, is composed of squash, such as a zucchini, stuffed with rice and meat. The preparation of Kousa Mahshi customarily requires the use of a manakra to core first the squash so that it can be stuffed with the rice and meat. A manakra is employed because the squash must stay whole during the coring process and manakras, due to a coring portion defined by an elongated, curved body having hollow area, are particularly suitable for such coring. In this regard, manakras are well known to enable the coring of squash and other fruits and vegetables without affecting the structural integrity thereof.

Manakras are customarily operated by grasping a handle portion disposed adjacent to the coring portion and manually manipulating the coring portion in a digging fashion through the center core area of the targeted fruit or vegetable. A problem which still exists, however, is that the manual actuation of a manakra is well known to be a very strenuous task. Moreover, using traditional scoops and knives as an alternative to core produce can cause injuries such as cuts to a user's palms or fingers. Thus, there remains a need for an electrical rotating coring apparatus which would eliminate the need for a user to provide substantial manual force in coring a fruit or vegetable with a manakra coring structure. It would be helpful if such an electrical rotating coring apparatus included a electrically driven motor which was configured to automatically rotate the manakra coring structure. It would be additionally desirable for such an electrical rotating coring apparatus to configured to operate on electrical power from an internal battery power or from an external source.

The Applicant's invention described herein provides for a coring apparatus adapted to electrically drive a manakra coring structure rotationally from an internal or external power source. The primary components in Applicant's electrical rotating coring apparatus are a coring base, a manakra coring structure, and a power source. When in operation, the electrical rotating coring apparatus enables fruits or vegetables to be cored with a manakra style structure through the application of electrical power as opposed to manual power. As a result, many of the limitations imposed by prior art coring structures are removed.

### SUMMARY OF THE INVENTION

An electrical rotating coring apparatus for coring a squash in the preparation of Kousa Mahshi. The electrical rotating coring apparatus comprises a base member, a manakra dock, a securing ring, and a conventional manakra. The base member is an electrically powered rotational device which enables a user to hold and utilize the electrical rotating coring apparatus. The manakra dock enables the electrical rotating coring apparatus to receive, hold and spin the manakra. The securing ring is configured to mechanically attach to manakra dock and lock a manakra in place on the manakra dock. An electric motor and battery are disposed in the base member to generate the rotation from electricity. The motor driven electricity is utilized to cause a manakra held in the manakra dock by a securing to spin.

It is an object of this invention to provide an electrical rotating coring apparatus which would eliminate the need for a user to provide substantial manual force in coring a fruit or vegetable with a manakra coring structure.

It is another object of this invention to provide an electrical rotating coring apparatus included a electrically driven motor which was configured to automatically rotate the manakra coring structure.

It is yet another object of this invention to provide an electrical rotating coring apparatus to configured to operate on electrical power from an internal battery power or from an external source.

These and other objects will be apparent to one of skill in the art.

### BRIEF DESCRIPTION OF THE DRAWINGS

FIG. 1 is a front elevational view of an electrical rotating coring apparatus built in accordance with the present invention having a conventional manakra in place.

FIG. 2 is a front elevational view of the conventional manakra employed as part of an electrical rotating coring apparatus built in accordance with the present invention.

FIG. 3 is a side elevational view of the conventional manakra employed as part of an electrical rotating coring apparatus built in accordance with the present invention.

FIG. 4 is a top plan view of the conventional manakra employed as part of an electrical rotating coring apparatus built in accordance with the present invention.

FIG. 5 is a top plan view of an electrical rotating coring apparatus built in accordance with the present invention with no manakra in place.

FIG. 6 is an exploded front elevational view of an electrical rotating coring apparatus built in accordance with the present invention with no manakra in place.

FIG. 7 is a top plan view of the securing ring of an electrical rotating coring apparatus built in accordance with the present invention.

### DETAILED DESCRIPTION OF THE INVENTION

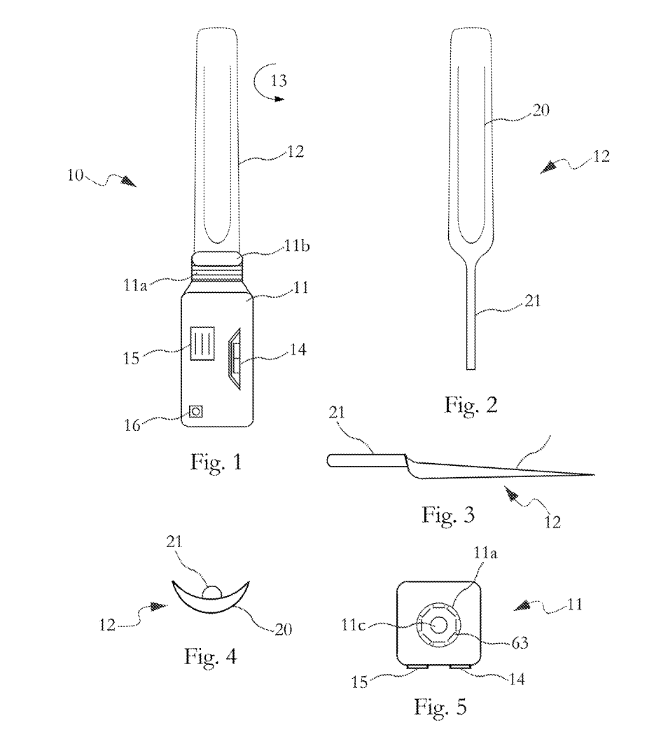

Referring now to the drawings and in particular FIG. 1, an electrical rotating coring apparatus 10 is shown having a base member 11, a manakra dock 11a, a securing ring 11b, and a conventional manakra 12. The base member 11 is an electrically powered rotational device which includes an internal electric motor mechanically attached to the manakra dock 11a and electrically connected to a battery disposed in an internal battery slot. The securing ring 11b is configured to mechanically attach to manakra dock 11a. The electric motor is configured to cause the manakra dock 11a and the securing ring 11b to spin such that a manakra 12 which is engaged to the manakra dock 11a and secured in place by the securing ring 11b will rotate in a coring direction 13. The base member 11 is structured to provide an area for a user of the rotating coring apparatus 10 to hold while operating the rotating coring apparatus 10. The exterior of the base member 11 includes a mechanical power switch 14 and a battery door 15. The mechanical power switch 14 is electrically connected to the electric motor and adapted to selectively cause the electric motor to perform its motoring action at a first speed, second speed, and third speed or to stop performing its motoring action. Through its mechanical connection to the manakra dock 11a, the performance of motoring action by the electric motor cause the manakra dock to rotate. In one embodiment, the mechanical power switch 14 additionally can cause the electric motor to rotate the manakra dock 11a in the direction opposite the coring direction 13 at each of the speeds. The battery door 15 provides access to the battery slot so that a user can place or replace a battery in the base member 11. The battery in place in the battery slot provides electrical power to the electric motor.

In one embodiment, an electrical jack 16 is additionally included on the base member 11 to enable the electrical rotating coring apparatus 10 to be connected to an electrical wire (not shown), and connected to an electrical plug to access electrical power therefrom.

Referring now to FIGS. 2, 3, and 4, the structure of a conventional manakra 12 includes a coring portion defined by an elongated, curved body having hollow area and a handle area. Typically, the manakra is utilized by a user grasping the handle area and actuating the manakra 12 in a manner which causes the coring area to engage the section of the fruit or vegetable to be cored. It is contemplated that a conventional manakra 12 having a handle portion sized to fit in the manakra dock of an electrical rotating coring apparatus built in accordance with the present invention may be inserted into and operated with the electrical rotating coring apparatus. It is further contemplated that the manakra dock of the present invention may be removable and interchangeable with manakra docks which are built in accordance with the present invention of different sized.

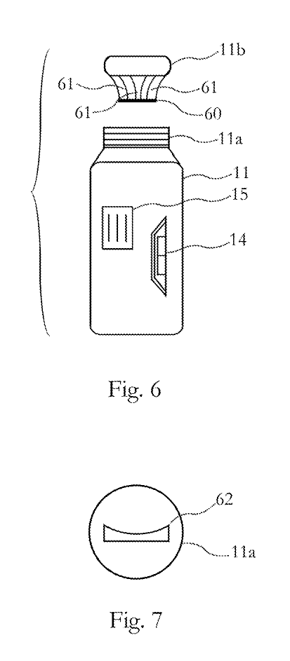

Referring now to FIGS. 1, 5, 6 and 7, the manakra dock 11a is sized and shaped to receive the handle portion of a conventional manakra 12. The manakra dock 11a includes a handle slot 11c which enables it to receive the handle portion of a manakra 12. The securing ring 11b includes a fastening lip 60 and is located, sized and shaped to snap in place on the manakra dock 11a. The securing ring 11b additionally includes a plurality gripping ridges 61 and receiving aperture 62. The gripping ridges 61 are sized and shaped to engage a plurality of grooves 63 on the manakra dock 11a to assure the manakra dock 11a and the securing ring 11b rotate in concert. The receiving aperture 62 is sized and shaped to enable the securing ring 11b to slide over the curved coring portion of a conventional manakra 12 and be fitted against the curved sides thereof when in place over such a manakra 12 on the base member 11. When snapped in place on top of the base member 11, the securing ring 11a secures in place a manakra 12 which has been inserted in the base member 11 and engaged with the manakra dock 11c thereof, enabling the manakra 12, manakra dock 11c and the securing ring 11b to rotate in a selected direction.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. An electrical rotating coring apparatus, comprising:
a base member having an electric motor configured to convert electricity to mechanical rotation and a power source;
a manakra dock integral with said base member, wherein said manakra dock is adapted to receive and hold a manakra;
a securing ring releasably attachable to said manakra dock, wherein said securing ring is configured to lock a manakra in place in the manakra dock; and
wherein said electrical rotating coring apparatus is configured to cause a manakra locked in place thereon to selectively rotate in at least a first direction.

2. The electrical rotating coring apparatus of claim 1, wherein the power source is a battery disposed inside said base member.

3. The electrical rotating coring apparatus of claim 2, additionally comprising an alternate power source defined as an electrical jack connected to an electrical wall plug.

4. The electrical rotating coring apparatus of claim 1, wherein the power source is an electrical jack connected to an electrical wall plug.

5. The electrical rotating coring apparatus of claim 1, wherein the manakra dock includes a handle slot adapted to receive the handle portion of a manakra.

6. The electrical rotating coring apparatus of claim 1, wherein the securing ring includes a receiving aperture adapted to enable the securing ring to slide over the curved coring portion of a conventional manakra and be fitted against the curved sides thereof when in place over such a manakra on the base member.

7. The electrical rotating coring apparatus of claim 1, wherein:
the manakra dock includes a plurality of grooves; and
the securing ring additionally includes a plurality of ridges, wherein the plurality of ridges and plurality of grooves are adapted to engage each other when the securing ring is on place on the manakra dock, causing the securing ring and the manakra dock to be fixed together such that they rotate in concert.

8. An electrical rotating coring apparatus, comprising:
a base member having an electric motor configured to convert electricity to mechanical rotation, a battery and an alternate power source defined as an electrical jack connected to an electrical wall plug;
a manakra dock integral with said base member, wherein said manakra dock includes a handle slot adapted to receive the handle portion of a manakra, enabling it to receive and hold a manakra ;
a securing ring releasably attachable to said manakra dock, wherein said securing ring is configured to lock a manakra in place in the manakra dock and includes a receiving aperture adapted to enable the securing ring to slide over the curved coring portion of a conventional manakra and be fitted against the curved sides thereof when in place over such a manakra on the base member; and
wherein the manakra dock includes a plurality of grooves, the securing ring additionally includes a plurality of ridges, wherein the plurality of ridges and plurality of grooves are adapted to engage each other when the securing ring is on place on the manakra dock, causing the securing ring and the manakra dock to be fixed together such that they rotate in concert, and said electrical rotating coring apparatus is configured to cause a manakra locked in place thereon to selectively rotate in at least a first direction.

9. An electrical rotating coring apparatus, comprising:
a base means for holding and utilizing the electrical rotating coring apparatus;
a dock means for to receiving, holding and spinning the manakra;
a securing means for attaching to the dock means and locking a manakra in place on the dock means; and
wherein said electrical rotating coring apparatus is configured to cause a manakra locked in place thereon to selectively rotate in at least a first direction.
